(19) United States
(12) Patent Application Publication
(10) Pub. No.: US 2021/0370408 A1
(43) Pub. Date: Dec. 2, 2021

(54) APPARATUS FOR POWDER DEPOSITION MECHANISM IN AN ADDITIVE MANUFACTURING PROCESS

(71) Applicant: INTECH DMLS PVT LTD, Bengaluru (IN)

(72) Inventor: Sridhar BALARAM, Bengaluru (IN)

(73) Assignee: INTECH DMLS PVT LTD, Bengaluru (IN)

(21) Appl. No.: 17/284,417

(22) PCT Filed: Oct. 11, 2019
(86) PCT No.: PCT/IB2019/058673

§ 371 Date: Apr. 9, 2021

(30) Foreign Application Priority Data
Oct. 12, 2018 (IN) 201841038740

(51) Int. Cl. B22F 12/67; B22F 12/30; B22F 12/41; B22F 12/90; B22F 12/50; B33Y 30/00

(52) U.S. Cl. CPC B22F 12/67; B22F 12/30; B22F 12/41; B22F 10/85; B22F 12/50; B33Y 30/00; B22F 12/90

(57) ABSTRACT

The present invention provides an apparatus for powder deposition mechanism in an additive manufacturing process. The apparatus comprises at least two belt driven cyclic arms which are configured to travel only in forward direction. The movement of the cyclic arm is such that a first arm is in movable position and a second arm is in stationary position simultaneously. A Programmable Logic Controller (PLC) controls the movement of the arm. At least one speed adjusting module is configured to adjust the speed of the cyclic arms. The speed adjusting module detects the limiting position of the cyclic arms. A vertical loop is configured to translate recoating arms in the vertical plane and horizontal plane. The vertical loop facilitates the automatic recoater arm changing mechanism.

### PRIORITY CLAIM

This application claims priority from the Complete application numbered 201841038740 filed with Indian Patent Office, Chennai on 12 Oct. 2018 titled “An apparatus for powder deposition mechanism in an additive manufacturing process”, the entirety of which is expressly incorporated herein by reference.

### DESCRIPTION OF THE INVENTION

### Technical Field of the Invention

The present invention relates to an apparatus for powder deposition mechanism in an additive manufacturing process. More specifically, the invention relates to the powder deposition mechanism in which a plurality of cyclic arms configured to travel only in a forward direction.

### Background of the Invention

‘Additive manufacturing,’ or ‘3D Printing,’ is a manufacturing process in which a 3D model of an object to be fabricated to an apparatus (e.g. a 3D printer), which then autonomously fabricates the object by gradually depositing, or otherwise forming, the constituent material in the shape of the object to be fabricated. For instance, successive layers of material that represent cross-sections of the object are deposited or otherwise formed. Generally, the deposited layers of material fuse to form the final object. Because of their relative versatility, additive manufacturing techniques have generated much interest.

Additive manufacturing process involves depositing layers of metal powder to be melted using a laser to produce a dense part, a metallic arm traverses on the platform to deposit an even layer of material throughout the exposed area of the platform. After travelling the farthest, the arm travels back to its home position to collect powder for the next layer.

It is important to use a greater amount of powder that melts and solidifies in fine form for the room. The excess powder ensures that the powder layer covers the target surface. For instance, from the powder reservoir or from an area above which the discharge arm is located. In addition, the dimensions of the area are not adjustable, but determined by the length of the spreading device or the discharge arm. In addition, it is common practice to provide the excess powder projecting beyond the target surface for each layer, in particular to ensure that the entire target surface is completely covered by the powder layer.

The backward travel of the arm is a non-value adding activity and since additive manufacturing is a layer wise repetitive process the backstroke contributes a huge portion of the machine running time driving up the process time & cost.

The U.S. Patent Publication No U.S. Pat. No. 6,375,874B1 titled “Method and apparatus for prototyping a three-dimensional object” discloses a printer that forms three-dimensional objects from a powder by selectively applying a binder liquid to incremental layers of the powder. The binder binds layers of the powder into solid two-dimensional cross sections of the desired object provided from memory. The printer can use dithering and halftoning techniques to shade the object and can also print in color. A filtration system removes airborne powder and recirculates the clean air. The printer also includes additional features to manage excess and airborne powder. However, the system relates to backward movement of the arm.

The U. Patent Publication No. CN108162400A titled “Automatic feeding and receiving device for 3D additive manufacturing” discloses a fully automatic feeding and receiving device for 3D additive manufacturing, which is used for effectively solving the problems of low efficiency and misoperation of manual operation. The invention provides a fully automatic feeding and receiving device for 3D additive manufacturing, comprising: two symmetrical conveyor belts and a pair of opposite radiation sensors. The pair of radiation sensors are arranged in pairs on the two symmetrical conveyor belts. The fiber optic sensor is disposed at the end of the conveyor belt. The printing platform of the material carrier is matched, and the printing platform can be embedded between the two symmetrical conveyor belts. However, the movement of the belt and arm does not restrict to a one direction.

Hence, there exists a need for an apparatus for powder deposition mechanism in an additive manufacturing process in an efficient manner.

### SUMMARY OF THE INVENTION

The present invention overcomes the drawbacks in the prior art and provides an apparatus for powder deposition mechanism in an additive manufacturing process.

In an embodiment, the apparatus comprises at least two belt driven cyclic arms which are configured to travel only in a forward direction. The movement of the cyclic arm is such that a first arm is in movable position and a second arm is in stationary position simultaneously.

The forward direction of the dual belt driven cyclic arms accelerates the additive manufacturing process. Further, the forward direction travel of the cyclic arms ensures debris and impurities move in only one direction and is taken out of processing zone with every coating. A Programmable Logic Controller (PLC) controls the movement of the arm.

In an embodiment, a dual recoater arms connects at least two frames which are parallel to each other. At least one speed adjusting module configured to adjust the speed of the cyclic arms. The speed adjusting module detects the limiting position of the cyclic arms. A plurality of position switches is configured to send signals when arms reach a limiting position or a predefined position according to the mechanical requirement.

In an alternative embodiment, a vertical loop is configured to translate recoating arms in the vertical plane and horizontal plane. The vertical loop facilitates the automatic recoater arm changing mechanism. A build movable built platform having a powder bed is configured to collect deposited powder. The build movable platform coupled with the dual recoater arms.

A dispenser in the platform moves up and down to spread the powder in the platform and the dispenser up mechanism includes build platform down, powder dispensing, coating powder and laser melting.

Thus, the invention avoids the backward stroke of the cyclic arm. The costs are reduced. The design is simple hence the build time is reduced.

The present invention reduces the manufacturing cost. The complexity of the locking cyclic arms reduced.

The present invention reduces the complexity as well as the manufacturing cost. The accessibility of the build platform during the recoating become easy. The invention minimizes the number of parts in accomplishing the aim which makes it simple, easy to install and inexpensive. The invention is of unitary construction and inexpensive to manufacture.

### BRIEF DESCRIPTION OF DRAWINGS

The foregoing and other features of embodiments will become more apparent from the following detailed description of embodiments when read in conjunction with the accompanying drawings. In the drawings, like reference numerals refer to like elements.

FIG. 1 illustrates an apparatus for powder deposition mechanism in an additive manufacturing process.

FIG. 2 illustrates dispenser up mechanism according to one embodiment of the invention.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

The present invention provides an apparatus for powder deposition mechanism in an additive manufacturing process. The apparatus comprises at least two belt driven cyclic arms which are configured to travel only in forward direction. The movement of the cyclic arm is such that a first arm is in movable position and a second arm is in stationary position simultaneously. A Programmable Logic Controller (PLC) controls the movement of the arm. At least one speed adjusting module is configured to adjust the speed of the cyclic arms. The speed adjusting module detects the limiting position of the cyclic arms. A vertical loop is configured to translate recoating arms in the vertical plane and horizontal plane. The vertical loop facilitates the automatic recoater arm changing mechanism.

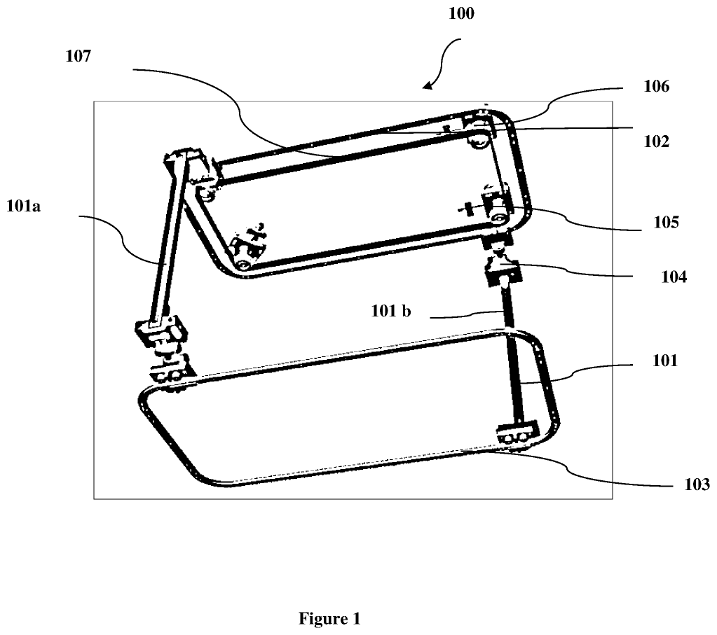

FIG. 1 illustrates an apparatus for powder deposition mechanism in an additive manufacturing process. In an embodiment, at least two belt driven cyclic arms (101a, 101b) are configured to travel only in forward direction. The movement of the cyclic arm (101a, 101b) is such that a first arm (101a) is in movable position and a second arm is in stationary position (101b) simultaneously.

The forward direction of the dual belt driven cyclic arms (101a, 101b) accelerate the additive manufacturing process. The forward direction travel of the cyclic arms (101a, 101b) ensures debris and impurities move in only one direction and is taken out of processing zone with every coating.

A Programmable Logic Controller (PLC) controls the movement of the arm (101a, 101b). The cyclic arms (101a, 101b) are coupled to the belt (107) and the belt (107) is driven by a pulley which is connected to a motor. The motor is controlled by a driver circuit.

In an embodiment, a dual recoater arms (101a, 101b) connect at least two frames (102, 103) which are parallel to each other. A plurality of removably attached blades are mounted on the arm (101a, 101b). The removably attached blades helps in replacing the damaged blades easily.

In an alternative embodiment, a plurality of position switches is configured to send signals when arms (101a, 101b) reach a limiting position or a predefined position according to the mechanical requirement. The position switches are connected to the PLC. The belt (107) controls the timing control of the powder bed.

Position switches are simple electrical devices that sends signal to the system when the arms (101a, 101b) reach a limiting position or a predefined position according to the mechanical requirement.

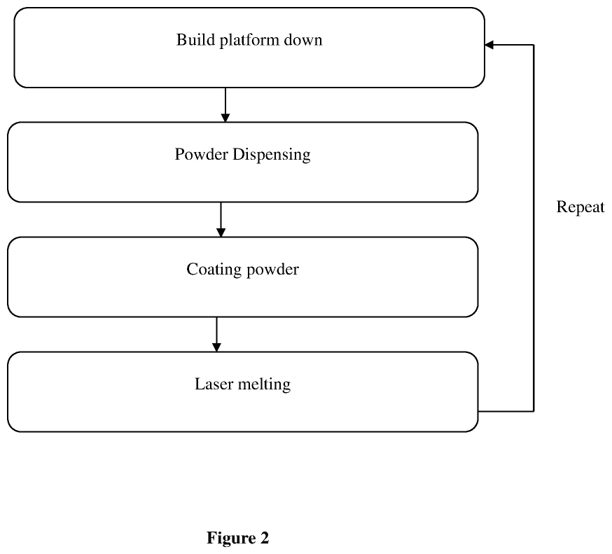

FIG. 2 illustrates dispenser up mechanism according to one embodiment of the invention. In an embodiment, a vertical loop is configured to translate recoating arms (101a, 101b) in the vertical plane into horizontal plane and vice versa. The vertical loop facilitates the automatic recoater arm changing mechanism.

The vertical loop translates the recoating arms (101a, 101b) in the vertical plane, unlike the other systems where the motion of the arm (101a, 101b) is restricted to horizontal plane only. Also, since the dual arm system is a vertical plane, it facilitates the automatic recoater changing mechanism.

A build movable built platform is provided which comprises a powder bed that is configured to collect deposited powder. The build movable platform coupled with the dual recoater arms and a dispenser in the platform moves up and down to spread the powder in the platform. The dispenser up mechanism includes build platform down, powder dispensing, coating powder and laser melting.

The dispenser up mechanism includes a build platform which comprises a powder dispensing process. The process further includes powder coating and laser melting.

Thus, the invention avoids the backward stroke of the cyclic arm. The costs are reduced. The design is simple hence the build time is reduced.

The present invention reduces the complexity as well as the manufacturing cost. The accessibility of the build platform during the recoating become easy. The invention minimizes the number of parts in accomplishing the aim which makes it simple, easy to install and inexpensive. The invention is of unitary construction and inexpensive to manufacture. In addition, the invention may be varied in size and dimension to accommodate in different vehicles. However, the basic structural features described above will remain the same.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

Reference numbers

| Components | Reference numbers |
|---|---|
| Belt driven cyclic arms | 101/(101a, 101b) |
| Frames | 102, 103 |
| Clamp body | 104 |
| Idler | 105 |
| Drive | 106 |
| Belt | 107 |

We claim:

1. An apparatus (100) for powder deposition mechanism in an additive manufacturing process, the apparatus (100) comprising:
a. at least two belt driven cyclic arms (101) configured to travel only in forward direction, wherein the movement of the cyclic arm (101) is such that a first arm (101a) is in movable position and a second arm (101b) is in stationary position simultaneously, wherein the forward direction of the dual belt driven cyclic arms (101) accelerate the additive manufacturing process, wherein the forward direction of the cyclic arms (101) ensure debris and impurities move in only one direction and is taken out of processing zone with every coating, wherein a Programmable Logic Controller (PLC) controls the movement of the arm (101);
b. a dual recoater arms, wherein the dual recoater arms connects at least two frames (102) which are parallel to each other;
c. at least one speed adjusting module configured to adjust the speed of the cyclic arms (101a, 101b), wherein the speed adjusting module detects the limiting position of the cyclic arms (101a, 101b);
d. a plurality of position switches configured to send signals when arms (101a, 101b) reach a limiting position or a predefined position according to the mechanical requirement;
e. a vertical loop configured to translate recoating arms (101a, 101b) in the vertical plane into horizontal plane and vice versa, wherein the vertical loop facilitates the automatic recoater arm changing mechanism; and
f. a build movable built platform having a powder bed configured to collect deposited powder, wherein the build movable platform coupled with the dual recoater arms (101a, 101b) using a clamp body (104) and an idler (105), wherein a dispenser in the platform moves up and down to spread the powder in the platform, wherein the dispenser up mechanism includes build platform down, powder dispensing, coating powder and laser melting.

2. The apparatus as claimed claim 1, wherein the cyclic arms (101a, 101b) are coupled to the belt (107) and the belt is driven by a pulley which is connected to a motor.

3. The apparatus as claimed claim 1, wherein the motor is controlled by a driver circuit.

4. The apparatus as claimed claim 1, wherein the belt (107) controls the timing control of the powder bed.

5. The apparatus as claimed claim 1, wherein a removably attachable coating blade is coupled with the arm (101a, 101b).

6. The apparatus as claimed claim 1, wherein the timing of dispenser mechanism and platform is controlled by the PLC.

7. The apparatus as claimed claim 1, wherein a plurality of removably attached blades are mounted on the arm (101a, 101b).
